(19) United States
(12) Patent Application Publication
(10) Pub. No.: US 2012/0193173 A1
(43) Pub. Date: Aug. 2, 2012

(54) ELEVATOR SYSTEM

(75) Inventor: Wei Wu, Tokyo (JP)

(73) Assignee: Mitsubishi Electric Corporation, Tokyo (JP)

(21) Appl. No.: 13/498,356

(22) PCT Filed: Dec. 17, 2009
(86) PCT No.: PCT/JP2009/071022

§ 371 Date: Mar. 27, 2012

(51) Int. Cl. B66B 3/00; B66B 1/18

(52) U.S. Cl. 187/384

(57) ABSTRACT

An elevator system including an authentication device by which a user before boarding an elevator car performs personal authentication, a destination floor registration device which automatically performs destination floor registration when personal authentication has been performed by the authentication device, a group controller which assigns an elevator to the registered destination floor, and an indication device which indicates the assigned machine number. When the machine number of the elevator assigned by the group controller is successively indicated, the indication device provides indications to each user by a prescribed method which permits discrimination between preceding and succeeding indications even when the machine number is the same. Thereby, the registration of a destination floor is performed during passage of a prescribed place, and a user who passes the above-described prescribed place can recognize the machine number of the elevator assigned to the user.

### TECHNICAL FIELD

The present invention relates to an elevator system which performs the operation control of a plurality of elevators.

### BACKGROUND ART

In an elevator system which performs the operation control of a plurality of elevators, when an elevator user registers a destination floor (a destination call), in consideration of the dynamic condition of each elevator an optimum elevator is assigned to the destination floor of the user from the above-described plurality of elevators.

As a conventional technique of an elevator system having the above-described configuration, there has been proposed an elevator system in which, for example, an elevator hail is provided with a registration device for registering destination floors and an indication device which indicates the machine No. of the assigned elevator (refer to Patent Literature 1, for example).

As another conventional technique, there has also been proposed an elevator system which is such that a registration device of a touch panel type display is installed in an elevator hall, whereby when a user registers a destination floor from the display, the machine No. of the elevator assigned to the user is indicated on the same display (refer to Patent Literature 2, for example).

Furthermore, as another conventional technique, there has been proposed an elevator system in which from (the position of) the gate through which a user has passed, the destination floor of the user is identified and automatic registration of a call is performed (refer to Patent Literature 3, for example). Incidentally, the elevator system described in Patent Literature 3 is provided with an indication device on the hall side of the gate so that a user can make sure of the machine No. of the elevator assigned to the user while passing through the gate.

### CITATION LIST

### Patent Literature

Patent Literature 1: Japanese Patent Laid-Open No. 1-226683
Patent Literature 2: UK Patent Application No. 2241090
Patent Literature 3: Japanese Patent Laid-Open No. 6-329344

### SUMMARY OF INVENTION

### Technical Problem

The elevator systems described in Patent Literature 1 and Patent Literature 2 are based on the supposition that an elevator user stops walking, registers a destination floor, and on the spot makes sure of the machine No. of the elevator which is assigned to the user. In this case, even when the user spends time to some extent in making sure of the machine No. of the elevator, this does not pose a problem.

On the other hand, in the case where a user registers a destination floor while passing a prescribed place as in the elevator system described in Patent Literature 3, it is not supposed that the user stays in that place, and it is usual that the indication of the machine No. of the elevator is carried out only in a given period of time (for example, several seconds).

For example, in the elevator system described in Patent Literature 3, it is necessary that the indication of the machine No. of the elevator be switched sequentially according to users who pass the gate. At this time, if the same elevator is assigned to users who pass through the gate earlier and later, the indication of the same machine No. of the elevator is performed. In this case, in particular, the user who passes through the gate later cannot make a judgment instantaneously as to whether the indication of the indication device is intended for the user himself or herself or for the other user who is in front of him or her, and feels embarrassed, posing a problem. Also, if such a situation occurs, the speed at which the users pass through the gate becomes slow or the users stop walking within the gate, resulting in the problem that the passage efficiency of the gate decreases.

Incidentally, in the elevator system described in Patent Literature 2, when a user has registered a destination floor, both the machine No. of the elevator assigned to the user and the destination floor of the user are indicated on a display (see FIG. 3). However, some users do not want other users to get to know the destination floor of the users, and also from the standpoint of security, this indication is not desirable.

The present invention was made to solve the problems described above, and an object of the invention is to provide an elevator system in which the registration of a destination floor is performed while passing a prescribed place, which is such that a user who passes the above-described prescribed place can surely recognize the machine No. of the elevator assigned to the user.

### Solution Problems

An elevator system of the present invention is an elevator system which performs the operation control of a plurality of elevators. The elevator system comprises an authentication device by use of which a user before boarding an elevator car performs personal authentication by inputting his or her personal information when passing a prescribed place, a destination floor registration device which automatically registers a destination floor of a user on the basis of the personal information inputted to the authentication device when personal authentication has been performed by the authentication device, a group controller which assigns an optimum elevator from the plurality of elevators to a destination floor registered by the destination floor registration device, and an indication device which causes the machine No. of the elevator assigned by the group controller to be indicated on an indicator and makes the user who passes the prescribed place recognize the machine No. of the elevator assigned to him or her. In the case where the machine No. of the elevator assigned by the group controller is successively indicated on the indicator, the indication device provides indications to each user by a prescribed method which permits discrimination between preceding and succeeding indications even when the machine No. is the same.

### Advantageous Effect of Invention

According to the present invention, in an elevator system in which the registration of a destination floor is performed while passing a prescribed place, it becomes possible for a user who passes the above-described prescribed place to surely recognize the machine No. of the elevator assigned to the user.

### BRIEF DESCRIPTION OF DRAWINGS

FIG. 1 is a block diagram showing an elevator system in a first embodiment according to the present invention.

FIG. 2 is a flowchart showing the actions of the elevator system in the first embodiment according to the present invention.

FIG. 3 is a diagram showing examples of indication of the indication device shown in FIG. 1.

FIG. 4 is a diagram showing another example of configuration of the indication device shown in FIG. 1.

FIG. 5 is a block diagram showing an elevator system in a second embodiment according to the present invention.

FIG. 6 is a flowchart showing the actions of the elevator system in the second embodiment according to the present invention.

FIG. 7 is a diagram showing an example of indication of the indication device shown in FIG. 5.

### DESCRIPTION OF EMBODIMENTS

The present invention will be described in more detail with reference to the accompanying drawings. Incidentally, in each of the drawings, like numerals refer to like or similar parts and redundant descriptions of these parts are appropriately simplified or omitted.

### First Embodiment

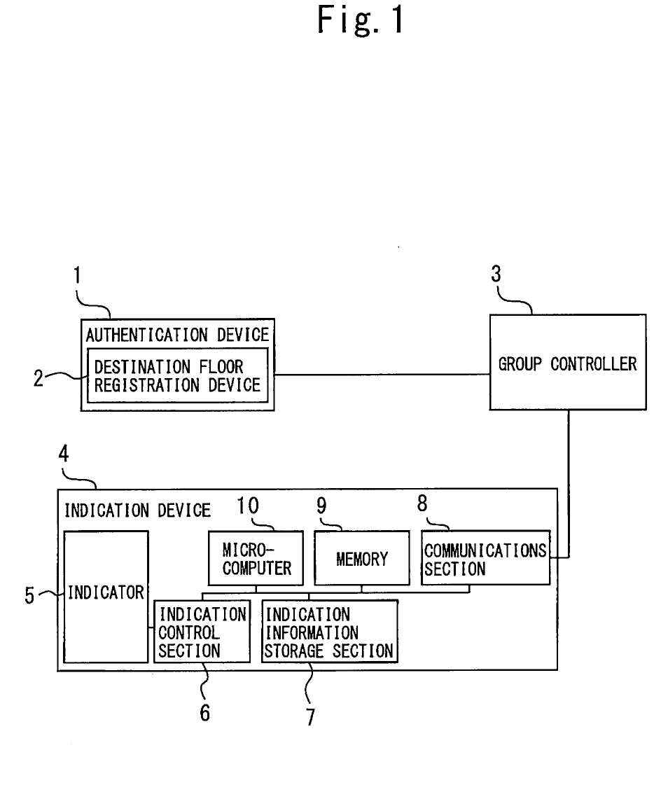

FIG. 1 is a block diagram showing an elevator system in a first embodiment according to the present invention.

In FIG. 1, reference numeral 1 denotes an authentication device by use of which a user before boarding an elevator car performs personal authentication by inputting information for identifying individuals (hereinafter referred to as “personal information”) while passing a prescribed place. The authentication device 1 makes a comparison between the inputted personal information and the preregistered information and makes a determination as to whether or not the person who inputted the personal information is a person who has been authorized to use the elevator (an authorized person). After authenticating by the above-described comparison that the person who has inputted the personal information is the authorized person himself or herself, the authentication device 1 outputs authentication information including the inputted personal information (or information corresponding thereto) to the destination floor registration device 2.

The destination floor registration device 2 has the function of automatically registering the destination floor of a user on the basis of the personal information inputted to the authentication device 1 when the personal authentication of the user has been performed by the authentication device 1. Upon input of the authentication information from the authentication device 1, the destination floor registration device 2 identifies a destination floor from the personal information included in the authentication information, and transmits a request for assignment including information on the destination floor to an elevator group controller 3. Incidentally, the information on the destination floor of each authorized person is stored beforehand in the destination floor registration device 2 by being correlated to the personal information of the user.

The above-described authentication device 1 and destination floor registration device 2 are provided integrally with a security device for limiting the passage of the prescribed place, for example. In this case, when a user inputs his or her personal information to the security device in order to pass the prescribed place, the authentication device 1 and the destination floor registration device 2 carry out personal authentication processing and automatic registration processing of a destination floor on the basis of the inputted personal information. Incidentally, examples of such a security device include a security gate through which users must pass when entering an elevator hall.

The group controller 3 performs the operation control of a bank of elevators composed of a plurality of elevators. That is, the group controller 3 has the function of selecting and assigning an optimum elevator from the above-described plurality of elevators for a destination floor which has been registered by the destination floor registration device 2. Upon receipt of the request for assignment from the destination floor registration device 2, the group controller 3 selects an elevator to be assigned to a destination floor (a user) in consideration of the dynamic condition of each elevator (for example, the position and movement direction of each elevator) so that the operation efficiency of the whole bank of elevators comes into an optimum condition, including reducing a waiting time for the user. Also, after performing assignment to a destination floor, the group controller 3 transmits an indication instruction of the assigned elevator to the indication device 4 in order to notify the user who has performed a call registration of the information.

The indication device 4 has the function of indicating the machine No. of the elevator assigned by the group controller 3, and making the user who passes the above-described prescribed place, i.e., the user who has performed the automatic registration of the destination floor recognize the machine No. of the elevator assigned to the user himself or herself. Incidentally, the machine No. of the elevator indicated in the indication device 4 refers to the information which enables one elevator to be identified from the above-described plurality of elevators which are group-controlled by the group controller 3.

The indication device 4 is such that the main part thereof comprises, for example, an indicator 5, an indication control section 6, an indication information storage section 7, a communications section 8, a memory 9, and a microcomputer 10.

The indicator 5 has the function of indicating machine No. of the elevator, and is formed from, for example, a liquid crystal display and a plasma display, an LED display, and a cathode-ray tube display. This indicator 5 is installed in the vicinity of the authentication device 1 so that the indication contents are easily seen from a user who passes the above-described prescribed place. Incidentally, the indicator 5 has any configuration so long as the indication of machine No. of the elevator can be performed using letters, graphics and the like.

The indication control section 6 has the function of controlling the processing of the indicator 5.

The indication information storage section 7 stores various kinds of information necessary for the indication of machine No. of the elevator. Specifically, data on the indication contents of machine No. of the elevator as well as correspondence tables of indication instructions from the group controller 3 and indication contents, data on wait screens and the like are stored in the indication information storage section 7.

The communications section 8 is intended for allowing the indication device 4 to carry out communications with external devices. The indication device 4 transmits various kinds of information to the group controller 3 and receives various kinds of information from the group controller 3 via this communications section 8. That is, an indication instruction of assigned elevators from the group controller 3 is obtained by the communications section 8. Incidentally, in this communications section 8 it is possible to adopt any communication method, such as wired transmission and wireless transmission, so long as information transmission is possible.

The memory 9 comprises, for example, a program memory for program and a working memory for work. The microcomputer 10 controls the processing of each of the sections 5 to 8 provided in the indication device 4 through the use of the above-described memory 9.

Incidentally, the above-described indication information storage section 7 and program memory may be formed from any storage device and storage element, such as a hard disk drive, a nonvolatile memory, and a dynamic random access memory. These may be formed from the same storage device or the same storage element. Also, for the indication control section 6, the indication information storage section 7, the communications section 8 and the memory 9, part or all of these may be incorporated in the microcomputer 10. Furthermore, when the communications section 8 is omitted, a detachable nonvolatile storage may be used in the indication device 4 as the indication information storage section 7.

In the indication device 4 having such a configuration, specific control is carried out so that a user who is passing the above-described prescribed place can surely recognize the machine No. of the elevator assigned to the user. For example, in the case where the personal authentication of multiple users is sequentially carried out, whereby the successive indications of the machine No. of the elevator are performed in a short period on the indicator 5, the indication device 4 provides indications to each user by a prescribed method which permits a discrimination between preceding and succeeding indications even when the machine No. is the same.

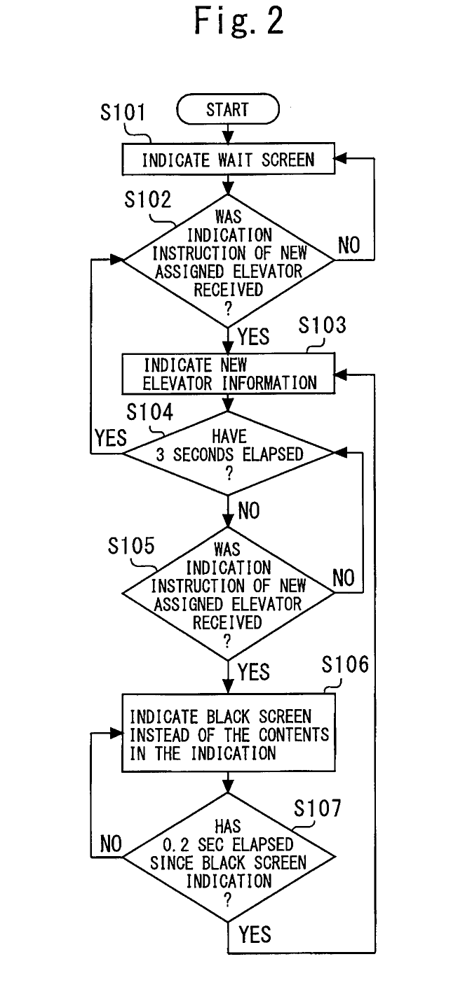

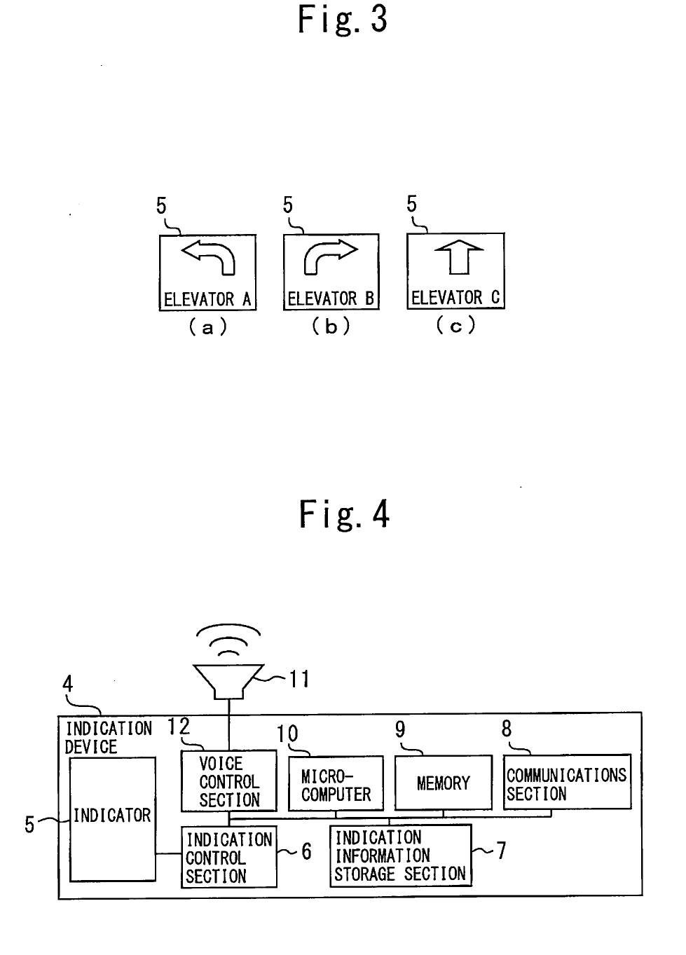

Referring also to FIGS. 2 and 3, a description will be given below of concrete actions of the indication device 4 having the above-described configuration. FIG. 2 is a flowchart showing the actions of the elevator system in the first embodiment according to the present invention. FIG. 3 is a diagram showing examples of indication of the indication device shown in FIG. 1.

The indication device 4 indicates a wait screen, such as a background screen, on the indicator 5 (S101), and makes a determination as to whether or not an indication instruction of the assigned elevator has been newly received from the group controller 3 (S102). When a new indication instruction has not been received from the group controller 3, the indication device 4 continues indicating a wait screen.

On the other hand, if assignment of the elevator to the user is carried out through the input of personal information to the authentication device 1 by this authorized person of the elevator, the indication instruction of the assigned elevator transmitted from the group controller 3 is received by the indication device 4 via the communications section 8 (Yes in S102). Upon receipt of the indication instruction of the assigned elevator, the indication device 4 indicates on the indicator 5 the elevator information including the machine No. of the assigned elevator on the basis of the received indication instruction (S103).

FIG. 3 shows examples of elevator information indicated on the indicator 5 in S103. In addition to information, such as “Elevator A” which constitutes the machine No. of the elevator, the installed position of the elevator, i.e., the direction in which the user is to move after passing the above-described prescribed position is also indicated by an arrow on the indicator 5. By indicating the movement direction of the user like this, for example, even in a building in which an elevator hall is not seen from a security gate (the place where destination floor registration is carried out), the user can move toward the hall without stopping after passing through the security gate. For this reason, there is no danger that the flow of users is interrupted in the area in the vicinity of the exit of the security gate.

Incidentally, in the case where the movement direction of the user is indicated on the indicator 5, for example, all that needed is that the data showing the direction of each elevator is registered beforehand in the indication information storage section 7.

In the examples of indication shown in FIG. 3, the destination floor of the user is not shown on the indicator 5. For this reason, there is no danger of the destination floor of the user who has performed destination floor registration coming to be known to other users who look at the indication of the indicator 5.

After indicating elevator information on the indicator 5, the indication device 4 makes a determination as to whether or not a prescribed first indication time (for example, 3 seconds) has elapsed since the start of the providing of the information (S104). Incidentally, when in S103, 3 seconds have elapsed since the start of the indication of the elevator information, the indication device 4 returns to the processing in S102 and a determination is made again as to whether or not an indication instruction of the assigned elevator has been newly received from the group controller 3. Unless a new indication instruction is received, the flow of processing returns to the processing in S101, where a wait screen is indicated on the indicator 5. That is, the indication of elevator information to one user is limited to the above-described first indication time at the maximum. Incidentally, this first indication time is not limited to the above-described 3 seconds and other values may be adopted. The first indication time is appropriately set, for example, according to the environment in which the indication device 4 is installed.

In the period of an elapse of 3 seconds since the start of the indication of elevator information in S103, the indication device 4 makes a determination as to whether or not an indication instruction of the assigned elevator has been newly received through the communication with the group controller 3 (S105). For example, in the case where multiple users pass through the security gate successively, if the personal authentication of a user who comes later is performed just after the personal authentication of a person who comes earlier is performed, in S105 it is determined that the indication instruction has been received. When an indication instruction is newly received in S105, the indication device 4 performs the switching of the indication of the indicator 5 even during the indication to the above-described user who comes earlier (that is, before an elapse of 3 seconds after the start of the indication of the elevator information to the user who comes earlier).

Specifically, upon receipt of a new indication instruction in S105, in order to make a discrimination of indications to the above-described earlier and later users clear, the indication device 4 indicates a prescribed blank screen on the indicator 5 after the deletion of the elevator information to the earlier user from the indicator 5 and before the indication of the elevator information to the later user on the indicator 5 (S106). Incidentally, a blank screen refers to a screen which is meaningless to users and is formed from, for example, a black screen or a white screen.

After indicating a blank screen on the indicator 5, the indication device 4 makes a determination as to whether or not a prescribed second indication time (for example, 0.2 second) has elapsed since the start of the indication (S107). When the second indication time has elapsed since the indication of the blank screen, on the basis of a new indication instruction received in S105 the indication device 4 indicates the elevator information, which includes the machine No. of the elevator assigned to the above-described later user, on the indicator 5 (S103).

Incidentally, this second indication time is not limited to the above-described 0.2 second, and other values may be adopted. The second indication time is appropriately set, for example, according to the environment in which the indication device 4 is installed.

According to the present invention, in an elevator system in which the registration of a destination floor is carried out when a user passes a prescribed place, for example, a security gate, it is possible to make a user who passes the above-described prescribed place surely recognize the machine No. of the elevator assigned to the user. That is, with the elevator system of the above-described configuration, even in the case where the machine No. of the elevator is successively indicated on the indicator 5 in a short period, a clear discrimination is made between preceding and succeeding indications. For this reason, each user does not become confused as to which indication is for himself or herself when passing the above-described prescribed place and can surely recognize the machine No. of the elevator assigned to him or her.

Incidentally, in this embodiment, as a method of making a clear discrimination between the preceding and succeeding indications, a concrete description was given of the case where a blank screen is inserted between the preceding and succeeding indications. However, the above-described indication method is not limited to this, and for example, it is possible to adopt methods, such as changing colors in the preceding and succeeding indications, changing the indication method, and attaching an outer frame or not attaching an outer frame.

FIG. 4 is a diagram showing another example of configuration of the indication device shown in FIG. 1. The indication device 4 shown in FIG. 4 is provided with an announcement device 11 and a voice control section 12 in addition to an indicator 5, an indication control section 6, an indication information storage section 7, a communications section 8, a memory 9, and a microcomputer 10. That is, the indication device 4 has also the function of providing voice information on the machine No. of the elevator assigned by the group controller 3 to the user who passes the above-described prescribed place.

The announcement device 11 has a voice output function and is installed, together with the indicator 5, in the vicinity of the authentication device 1. The voice control section 12 controls the announcement device 11. In the case where the indication device 4 has such a configuration, after performing assignment to a destination floor, the group controller 3 transmits a notification instruction of the assigned elevator to the indication device 4. Upon receipt of the notification instruction from the group controller 3 via the communications section 8, the indication device 4 indicates elevator information on the indicator 5 and performs the voice output of the same contents as the elevator information from the announcement device 11.

Incidentally, although FIG. 4 shows the case where the announcement device 11 and the voice control section 12 are arranged as part of the indication device 4, it is also possible to install a voice guidance device having the functions of the announcement device 11 and the voice control section 12 as a device separate from the indication device 4. In this case, after performing assignment to a destination floor, the group controller 3 transmits the notification instruction of the assigned elevator to both the indication device 4 and the voice guidance device.

### Second Embodiment

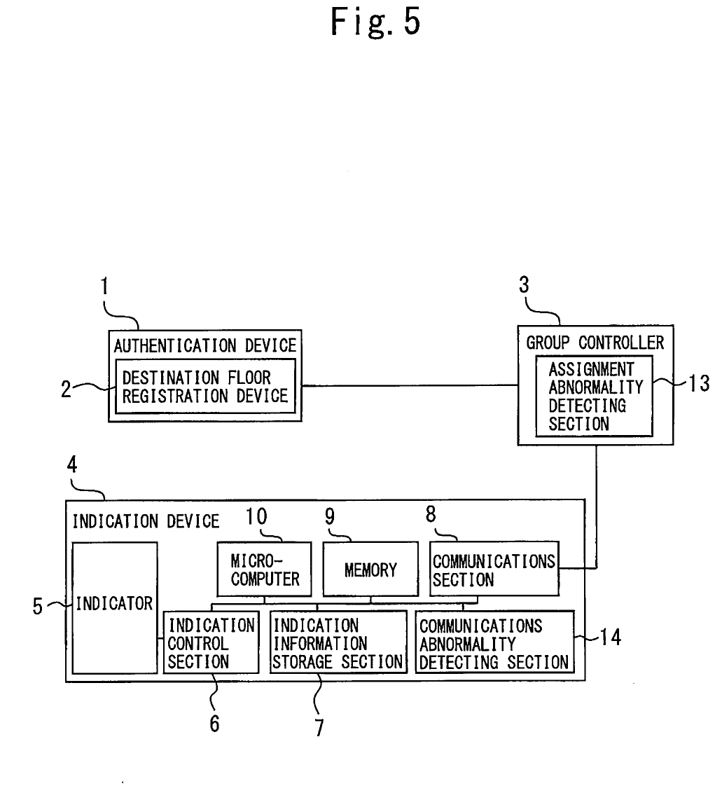

FIG. 5 is a block diagram showing an elevator system in a second embodiment according to the present invention. The elevator system of the present invention is based on the premise that a user registers a destination floor while passing a prescribed place, such as a security gate, and makes sure of the indication of the indication device 4. In such an elevator system, for example, in the case where the authentication device 1 is installed integrally with a security gate, if the flow of users is interrupted in the interior of the security gate or the area in the vicinity of the exit of the security gate, the passage efficiency decreases remarkably.

The elevator system of this embodiment is intended for solving such problems, and is configured in such a manner that in the case where it is impossible to indicate the machine No. of the elevator from the indicator 5 to a user who passes a prescribed place, the prescribed contents of the motions to be performed by the user after passing the prescribed place are indicated on the indicator 5. As a result of this, even in the case where it is impossible to indicate the machine No. of the elevator from the indicator 5 due to the occurrence of some abnormality, it is possible to prevent the flow of users from being interrupted in the above-described prescribed place or the area in the vicinity thereof.

Specifically, compared to the configuration of the first embodiment, in this elevator system, an assignment abnormality detecting section 13 is newly added to the group controller 3 and a communications abnormality detecting section 14 is newly added to the indication device 4. Incidentally, for the configuration of the indication device 4 except the communications abnormality detecting section 14, the configuration shown in FIG. 4 may be adopted.

The assignment abnormality detecting section 13 has the function of detecting that an abnormality has occurred in the assignment function of the group controller 3. In the case where a failure has occurred in the assignment means (not shown) which performs assignment in response to a request for assignment received from the destination floor registration device 2, in the case where the load of this assignment means is large and assignment processing cannot be performed within a prescribed period of time, and in other cases, the assignment abnormality detecting section 13 detects that an abnormality has occurred in the assignment function of the group controller 3. Incidentally, the assignment abnormality detecting section 13 may detect abnormalities in the assignment function also when the assignment means does not perform the function thereof, such as during the maintenance of elevators.

When an abnormality in the assignment function has been detected by the assignment abnormality detecting section 13, an assignment abnormality signal is transmitted from the group controller 3 to the indication device 4. Upon receipt of the assignment abnormality signal via the communications section 8, the indication device 4 indicates the contents of the above-described motion on the indicator 5.

The communications abnormality detecting section 14 has the function of detecting that an abnormality has occurred in the communication between the indication device 4 and the group controller 3. When a communications abnormality has been detected by the communications abnormality detecting section 14, the indication device 4 indicates the contents of the above-described motion on the indicator 5.

Incidentally, it is possible to adopt a configuration which is such that the group controller 3 is provided with another detecting section and the like, which detects that an abnormality has occurred in the communication with the destination floor registration device 2, whereby the above-described communications abnormality detecting section 14 is caused to detect communication failures between the devices constituting this system.

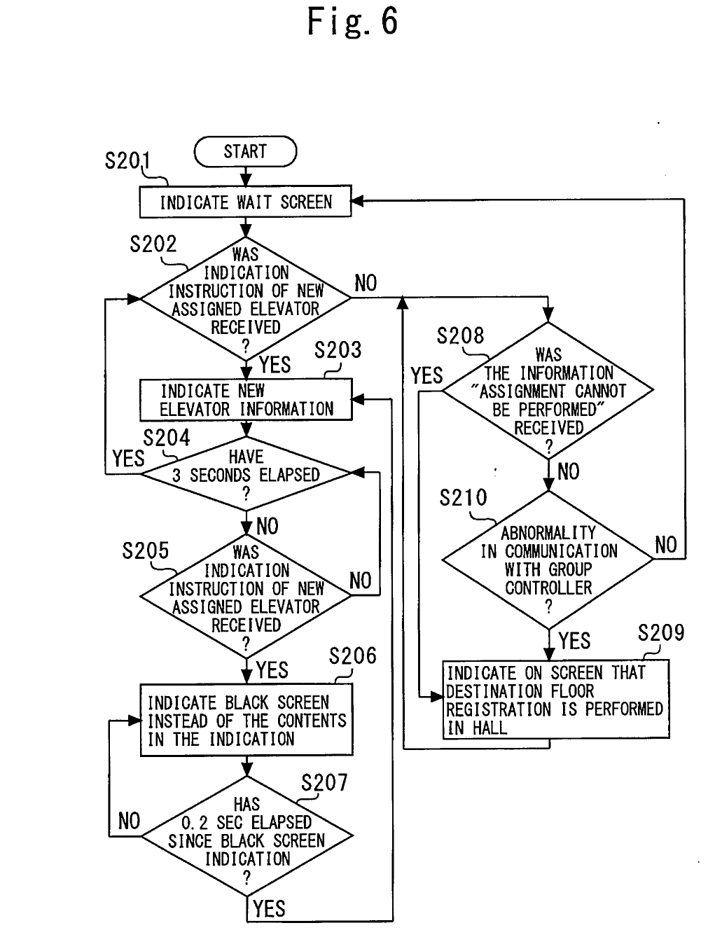

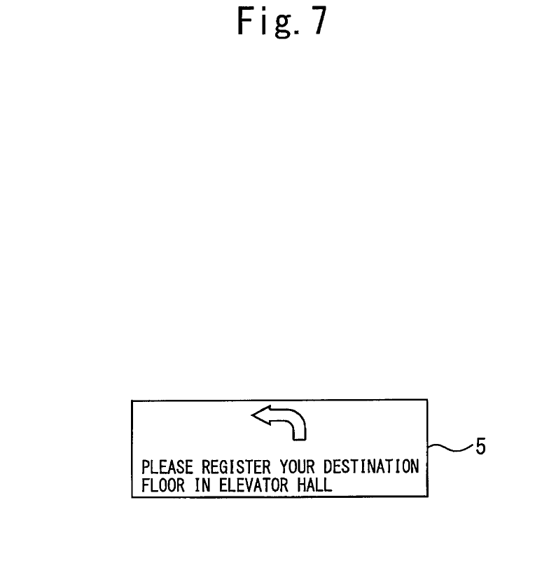

Next, referring also to FIGS. 6 and 7, a description will be given of specific actions of the indication device 4 having the above-described configuration. FIG. 6 is a flowchart showing the actions of the elevator system in the second embodiment according to the present invention, and FIG. 7 is a diagram showing an example of indication of the indication device shown in FIG. 5. Incidentally, because the processing in S201 to S207 of FIG. 6 is the same as the processing in S101 to S107 of FIG. 2, concrete descriptions thereof are omitted.

In the case where in S202 the indication instruction of a new assigned elevator was not received, the indication device 4 makes a determination as to whether or not information to the effect that assignment cannot be performed has been received from the group controller 3 (S208). In the case where a functional failure occurred in the above-described assignment means, in the case where an excessive load acted on the assignment means, and in other cases, when an abnormality in the assignment function is detected by the assignment abnormality detecting section 13, an assignment abnormality signal transmitted from the group controller 3 is received by the indication device 4 (Yes in S208). Upon receipt of the assignment abnormality signal, the indication device 4 indicates as the contents of the above-described motion, for example, information to the effect that the registration of a destination floor is performed in the hall of the elevator (S209).

Incidentally, FIG. 7 shows an example of indication of the indicator 5 in S209.

In the case where in S208 the indication device 4 did not receive the assignment abnormality signal, the indication device 4 next makes a determination as to whether or not an abnormality has occurred in the communication with the group controller 3 (S210). Here, when the detection of a communication abnormality by the communications abnormality detecting section 14 was performed, the indication device 4 indicates the contents of the above-described motion on the indicator 5 (S209). On the other hand, when the detection of a communication abnormality by the communications abnormality detecting section 14 was not performed, the indication device 4 indicates a wait screen on the indicator 5 (S201).

Incidentally, after indicating the contents of the above-described motion in S209, the indication device 4 continues indicating the contents of the above-described motion, alerting the users until the detection of abnormalities by both the assignment abnormality detecting section 13 and the communications abnormality detecting section 14 is not performed anymore.

### INDUSTRIAL APPLICABILITY

The elevator system of the present invention can be applied to an elevator system which notifies a user who has registered a destination floor before boarding an elevator car of the machine No. of the assigned elevator.

### REFERENCE SIGNS LIST

1 authentication device

2 destination floor registration device

3 group controller

4 indication device

5 indicator

6 indication control section

7 indication information storage section

8 communications section

9 memory

10 microcomputer

11 announcement device

12 voice control section

13 assignment abnormality detecting section

14 communications abnormality detecting section

1. An elevator system which performs the operation control of a plurality of elevators, comprising:
an authentication device by use of which a user before boarding an elevator car performs personal authentication by inputting his or her personal information when passing a prescribed place;
a destination floor registration device which automatically registers a destination floor of a user on the basis of the personal information inputted to the authentication device when personal authentication has been performed by the authentication device;
a group controller which assigns an optimum elevator from the plurality of elevators to a destination floor registered by the destination floor registration device; and
an indication device which causes the machine No. of the elevator assigned by the group controller to be indicated on an indicator and makes the user who passes the prescribed place recognize the machine No. of the elevator assigned to him or her,
wherein in the case where the machine No. of the elevator assigned by the group controller is successively indicated on the indicator, the indication device provides indications to each user by a prescribed method which permits discrimination between preceding and succeeding indications even when the machine No. is the same.

2. The elevator system according to claim 1, wherein in the case where before a prescribed period of time elapses after the indication of the machine No. of the elevator assigned by the group controller to a first user on the indicator, the machine No. of the elevator assigned to a second user is indicated on the indicator, the indication device indicates a prescribed blank screen on the indicator before the indication of the machine No. to the second user.

3. The elevator system according to claim 1, wherein in the case where the indication of the machine No. cannot be provided to a user who passes the prescribed place, the indication device indicates on the indicator the contents of a prescribed motion to be performed by the user after the passage of the prescribed place.

4. The elevator system according to claim 3, further comprising:
an assignment abnormality detecting section which is provided in the group controller and detects that an abnormality has occurred in the function of elevator assignment,
wherein upon detection of the occurrence of an abnormality in the function of elevator assignment by the assignment abnormality detecting section, the indication device indicates the contents of the motion on the indicator.

5. The elevator system according to claim 3, further comprising:
a communications abnormality detecting section which is provided in the indication device and detects that an abnormality has occurred in the communication with the group controller,
wherein upon detection of the occurrence of an abnormality in the communication with the group controller by the communications abnormality detecting section, the indication device indicates the contents of the motion on the indicator.

6. The elevator system according to claim 1, wherein the indication device indicates on the indicator the machine No. of the elevator assigned by the group controller along with the direction of movement of a user after passage of the prescribed place.

7. The elevator system according to claim 1, wherein the indication device does not indicate the destination floor of a user when the machine No. of the elevator assigned by the group controller is indicated on the indicator.

8. The elevator system according to claim 1, further comprising:
an announcement device which is installed in the vicinity of the authentication device and provides voice guidance on the machine No. of the elevator assigned by the group controller to a user who passes the prescribed place.

9. The elevator system according to claim 1, wherein the authentication device and the destination floor registration device are provided integrally with a security device for limiting the passage of the prescribed place, and perform personal authentication processing and automatic registration processing of the destination floor on the basis of the personal information inputted by a user to the security device in order to pass the prescribed place.
